(19) United States
(12) Patent Application Publication
(10) Pub. No.: US 2014/0195983 A1
(43) Pub. Date: Jul. 10, 2014

(54) 3D GRAPHICAL USER INTERFACE

(71) Applicants: Yangzhou Du, Beijing (CN); Qing Jian Song, Shanghai (CN); Wenlong Li, Beijing (CN); Tao Wang, Beijing (CN); Yimin Zhang, Beijing (CN)

(72) Inventors: Yangzhou Du, Beijing (CN); Qing Jian Song, Shanghai (CN); Wenlong Li, Beijing (CN); Tao Wang, Beijing (CN); Yimin Zhang, Beijing (CN)

(21) Appl. No.: 13/977,353

(22) PCT Filed: Jun. 30, 2012
(86) PCT No.: PCT/CN12/00903

§ 371 Date: Sep. 17, 2013

(51) Int. Cl. G06F 3/0481; G06F 3/01; G06K 9/00; G06T 15/20

(52) U.S. Cl. CPC G06F 3/04815; G06T 15/20; G06F 3/017; G06K 9/00201; G06K 9/00281
USPC 715/849; 345/419; 382/118

(57) ABSTRACT

Systems, apparatus, articles, and methods are described including operations for a 3D graphical user interface.

### BACKGROUND

Three dimensional (3D) display techniques have been well developed today. Large screen 3D-TVs are commonly available in the market and the price is closed to traditional 2D-TV.

Middle-size auto-stereoscopic 3D displays may be found in science museums as well as in trade exhibitions. Further, small-size glasses-free 3D displays may be equipped on the latest smart phones, such as HTC EVO 3D and LG Optimus 3D, for example.

Separately, 3D sensing techniques have been well developed. For example, the Microsoft Kinect may be utilized to sense 3D depth images directly. Similarly, the 3D camera has become a consumer level product. For example, the Fujifilm dual-lens camera may be utilized to capture stereoscopic images. Another 3D sensing technology is made by LeapMotion, who have recently developed a device for finger tracking in 3D space.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example 3D graphical user interface system;

FIG. 2 is a flow chart illustrating an example 3D graphical user interface process;

FIG. 3 is an illustrative diagram of an example 3D graphical user interface process in operation;

FIG. 4 is an illustrative diagram of an example 3D graphical user interface system in operation;

FIG. 5 is an illustrative diagram of an example 3D graphical user interface system;

FIG. 6 is an illustrative diagram of an example system; and

FIG. 7 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

Systems, apparatus, articles, and methods are described below including operations for a 3D graphical user interface.

As described above, in some cases, conventional 2D touch screens can do controller-free interaction. Such controller free interaction can also be done with image projection on a surface along with finger tip recognition. However, both of these examples are 2D graphical user interfaces and are performed on a 2D surface.

Similarly, conventional touch-less interaction systems (e.g., Microsoft Kinect for Xbox 360) systems may recognize hand/body gesture. However, such in touch-less interaction systems the graphical user interfaces remain 2D and the user can not “touch” virtual 3D widgets.

In early implementation of virtual reality, people were getting 3D perception through red-cyan glasses, while acquiring 3D position of fingers through data glove-type user input device. However, such systems were dependent on glove-type user input devices for user input.

As will be described in greater detail below, operations for a 3D graphical user interface may receive 3D user input without requiring a user input device. For example, a 3D display and 3D sensing techniques may be adapted to present such a 3D graphical user interface and receive 3D user input without requiring a user input device. More specifically, the 3D perception could be obtained without wearing special glasses and the 3D sensing of fingers could be done without any accessories (e.g., as may be done with a depth camera).

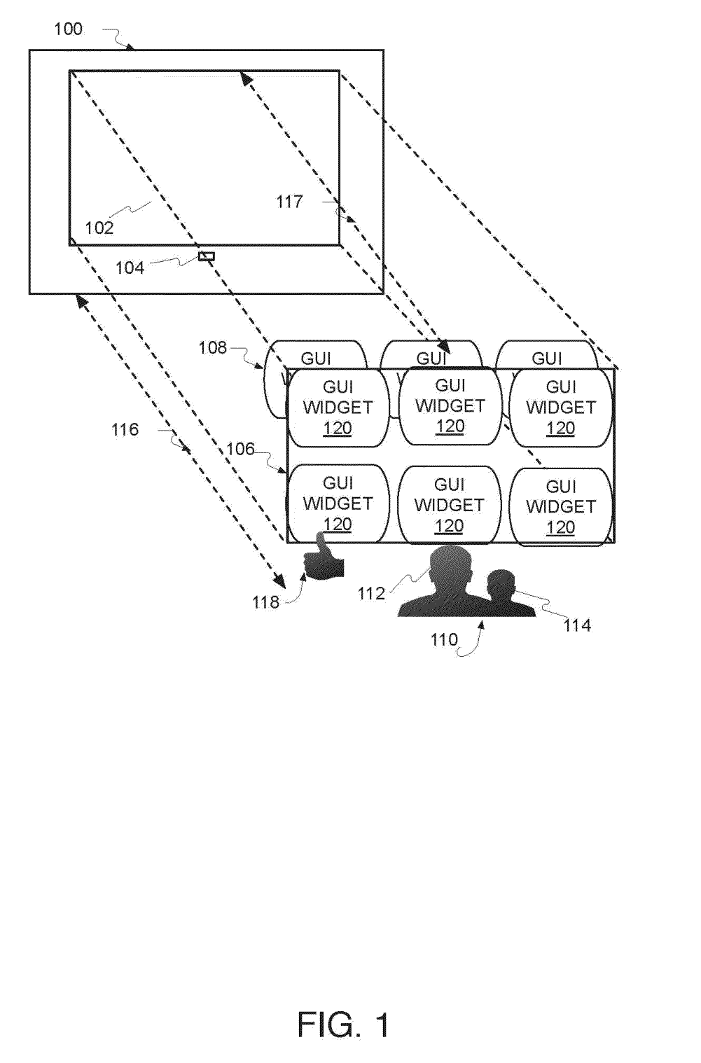

FIG. 1 is an illustrative diagram of an example 3D graphical user interface system 100, arranged in accordance with at least some implementations of the present disclosure. In the illustrated implementation, 3D graphical user interface system 100 may include a 3D display 102, one or more 3D imaging devices 104, and/or the like.

In some examples, 3D graphical user interface system 100 may include additional items that have not been shown in FIG. 1 for the sake of clarity. For example, 3D graphical user interface system 100 may include a processor, a radio frequency-type (RF) transceiver, and/or an antenna. Further, 3D graphical user interface system 100 may include additional items such as a speaker, a microphone, an accelerometer, memory, a router, network interface logic, etc. that have not been shown in FIG. 1 for the sake of clarity.

In some examples, 3D display 102 may include one or more of the following types of 3D displays: a 3D television, a holographic 3D television, a 3D cell phone, a 3D tablet, the like, and/or combinations thereof. For example, such a holographic 3D television may be similar to or the same as the television system discussed in McAllister, David F. (February 2002), “Stereo & 3D Display Technologies, Display Technology”, In Hornak, Joseph P. (Hardcover). Encyclopedia of Imaging Science and Technology, 2 Volume Set. 2, New York: Wiley & Sons. pp. 1327-1344. ISBN 978-0-471-33276-3.

In some examples, 3D visual data from 3D imaging devices 104 may be obtained from one or more of the following 3D sensor types: a depth camera-type sensor, a structured light-type sensor, a stereo-type sensor, a proximity-type sensor, a 3D camera-type sensor, the like, and/or combinations thereof. For example, such a 3D camera-type sensor may be similar to or the same as the sensor system discussed in http://web.mit.edu/newsoffice/2011/lidar-3d-camera-cellphones-0105.html. In some examples, 3D imaging devices 104 may be provided via either a peripheral device or as an integrated device in 3D graphical user interface system 100. In one example, a structured light-type sensor (e.g., such a s a device similar in function to Microsoft Kinect) may be capable of sensing the 3D location of body gestures, the virtual figure and the surrounding scene. However, conventional uses of such structured light-type sensors remain directed to output limited to planar visualization on a 2D screen. If 3D display 102 is combined with 3D sensing-type imaging devices 104 (e.g., such as a device similar to Microsoft Kinect), virtual objects may be jumped out of 3D display 102 and a user would be able to provide input with hands directly.

As will be described in greater detail below, 3D graphical user interface system 100 may include a 3D graphical user interface 106. Such a 3D graphical user interface 106 may include one or more user interactable widgets 108 that may be oriented and arranged as one or more menus, one or more buttons, one or more dialog boxes, the like, and/or combinations thereof. Such user interactable widgets 108 may be jumped out of 3D display 102 through stereo imaging, presented right in front of a user. In the illustrated example, one or more users 110 may be present. In some examples, 3D graphical user interface system 100 may differentiate between a target user 112 and a background observer 114 of the one or more users 110. In such an example, 3D graphical user interface system 100 may receive input from target user 112 and not background observer 114, and may adjust presentation of the 3D graphical user interface 106 based on a distance 116 between target user 112 and 3D display 102 (e.g., the distance can be extracted by depth/stereo camera-type imaging devices 104). For example, 3D graphical user interface system 100 may adjust presentation of the 3D graphical user interface 106 to a touchable distance 117 to user 112. When user 112 touches with these virtual widgets 108, widgets 108 may be able to respond to interaction from user 112. For example, gestures of hand 118 (e.g., which may include finger action) of user 112 3D graphical user interface 106 may be recognized with depth camera or stereo camera-type imaging devices 104.

The combination of 3D display 102 and 3D sensing imaging devices 104 may bring new opportunities for building 3D graphical user interface 106, which may allow user 112 interaction in a true immersive 3D space. For example, through stereoscopic glasses, a 3D-TV menu could be floating in the air and the buttons could be presented in touchable distance to user 112. When user 112 presses the virtual button, the button may respond to the user 112's input and the 3D TV may perform a task accordingly. Such 3D user input through 3D graphical user interface 106 may replace or augment user input through remote controller, keyboard, mouse, or the like.

Such a 3D graphical user interface system 100 may be built upon the adaptation of 3D display 102 and 3D sensing techniques. 3D graphical user interface system 100 may allow user 112 to perceive 3D graphical user interface 106 via stereo imaging and “touch” virtual 3D widgets 108 using hands 116 (e.g., which may include input from individual fingers). 3D graphical user interface 106 can be used for a 3D-TV menu, 3D game widgets, 3D phone interfaces, the like, and/or combinations thereof.

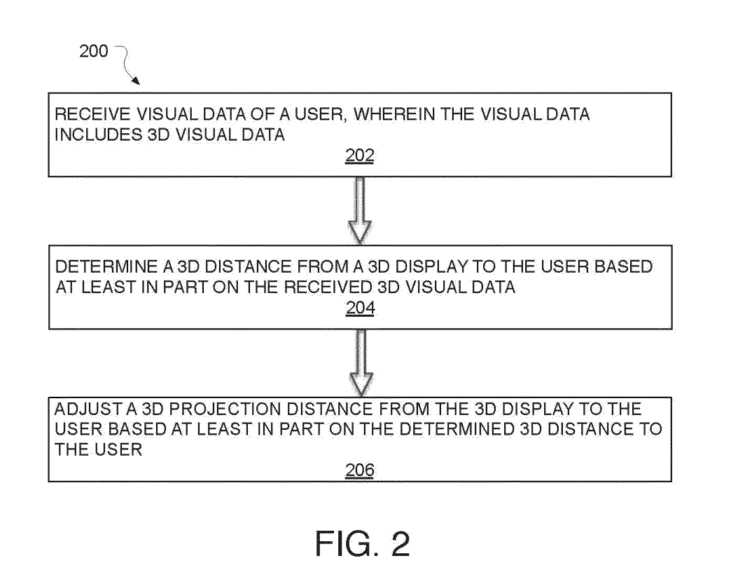

As will be discussed in greater detail below, 3D graphical user interface system 100 may be used to perform some or all of the various functions discussed below in connection with FIGS. 2 and/or 3.

FIG. 2 is a flow chart illustrating an example 3D graphical user interface process 200, arranged in accordance with at least some implementations of the present disclosure. In the illustrated implementation, process 200 may include one or more operations, functions or actions as illustrated by one or more of blocks 202, 204, and/or 206. By way of non-limiting example, process 200 will be described herein with reference to example 3D graphical user interface system 100 of FIGS. 1 and/or 5.

Process 200 may be utilized as a computer-implemented method for content aware selective adjusting of motion estimation. Process 200 may begin at block 202, “RECEIVE VISUAL DATA OF A USER, WHEREIN THE VISUAL DATA INCLUDES 3D VISUAL DATA”, where visual data of a user may be received. For example, visual data of a user may be received, where the visual data includes 3D visual data.

Processing may continue from operation 202 to operation 204, “DETERMINE A 3D DISTANCE FROM A 3D DISPLAY TO THE USER BASED AT LEAST IN PART ON THE RECEIVED 3D VISUAL DATA”, where a determination of a 3D distance may be made from a 3D display to the user. For example, a determination of a 3D distance may be made from a 3D display to the user based at least in part on the received 3D visual data.

In some examples, the 3D visual data may be obtained from one or more of the following 3D sensor types: a depth camera-type sensor, a structured light-type sensor, a stereo-type sensor, a proximity-type sensor, a 3D camera-type sensor, the like, and/or combinations thereof.

Processing may continue from operation 204 to operation 206, “ADJUST A 3D PROJECTION DISTANCE FROM THE 3D DISPLAY TO THE USER BASED AT LEAST IN PART ON THE DETERMINED 3D DISTANCE TO THE USER”, where a 3D projection distance from the 3D display to the user may be adjusted. For example, a 3D projection distance from the 3D display to the user may be adjusted based at least in part on the determined 3D distance to the user.

In some examples, the 3D display may include one or more of the following types of 3D displays: a 3D television, a holographic 3D television, a 3D cell phone, a 3D tablet, the like, and/or combinations thereof.

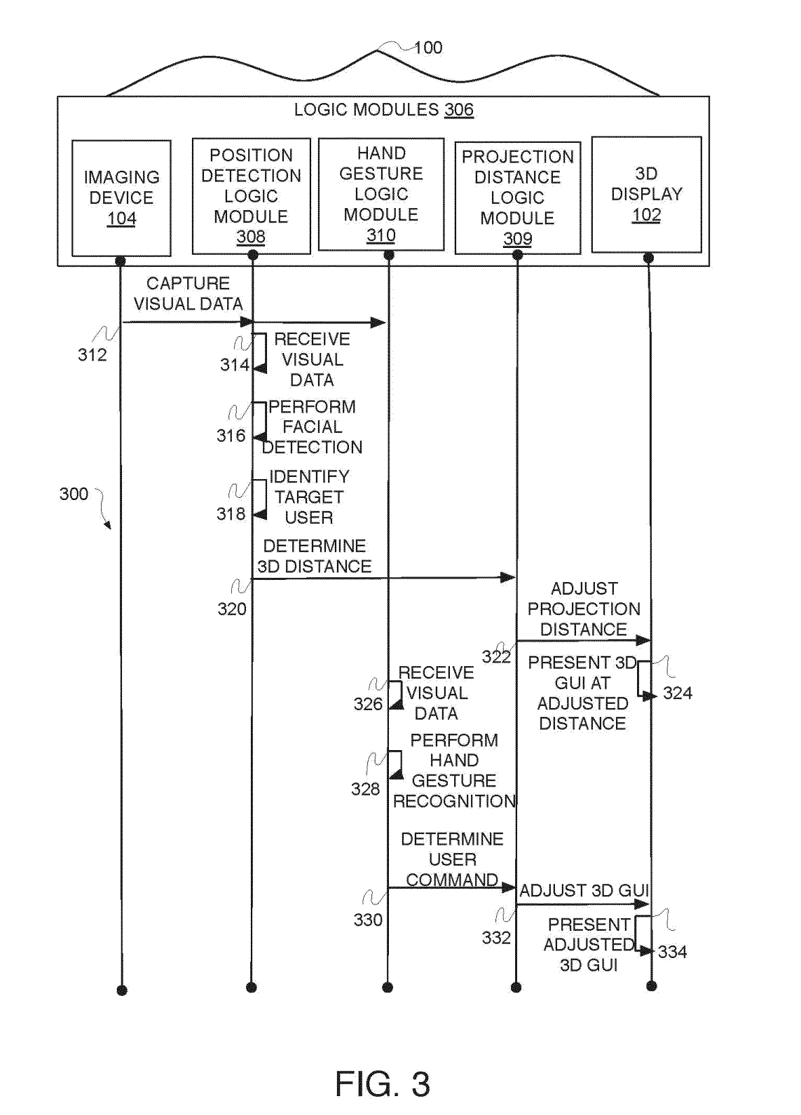

Some additional and/or alternative details related to process 200 may be illustrated in one or more examples of implementations discussed in greater detail below with regard to FIG. 3.

FIG. 3 is an illustrative diagram of example 3D graphical user interface system 100 and 3D graphical user interface process 300 in operation, arranged in accordance with at least some implementations of the present disclosure. In the illustrated implementation, process 300 may include one or more operations, functions or actions as illustrated by one or more of actions 312, 314, 316, 318, 320, 322, 324, 326, 328, 330, 332, and/or 334. By way of non-limiting example, process 300 will be described herein with reference to example 3D graphical user interface system 100 of FIGS. 1 and/or 5.

In the illustrated implementation, 3D graphical user interface system 100 may include logic modules 306. For example, logic modules 306, may include a position detection logic module 308, a projection distance logic module 309, a hand gesture logic module 310, the like, and/or combinations thereof. Although 3D graphical user interface system 100, as shown in FIG. 3, may include one particular set of blocks or actions associated with particular modules, these blocks or actions may be associated with different modules than the particular module illustrated here.

Processing may begin at operation 312, “CAPTURE VISUAL DATA”, where visual data may be captured. For example, capturing of visual data, where the visual data includes 3D visual data, may be performed via imaging device 104.

Processing may continue from operation 312 to operation 314, “RECEIVE VISUAL DATA”, where visual data may be received. For example, visual data may be transferred from imaging device 104 to logic modules 306, including position detection logic module 308 and/or hand gesture logic module 310, where the visual data includes 3D visual data.

Processing may continue from operation 314 to operation 316, “PERFORM FACIAL DETECTION”, where facial detection may be performed. For example, the face of the one or more users may be detected based at least in part on visual data via position detection logic module 308.

In some examples, such face detection may be configured to differentiate between the one or more users. Such facial detection techniques may allow relative accumulations to include face detection, motion tracking, landmark detection, face alignment, smile/blink/gender/age detection, face recognition, detecting two or more faces, and/or the like.

For, example, such face detection may be similar to or the same as the such face detection methods discussed in: (1) Ming-Hsuan Yang, David Kriegman, and Narendra Ahuja, “Detecting Faces in Images: A Survey”, IEEE Transactions on Pattern Analysis and Machine Intelligence (PAMI) vol. 24, no. 1, pp. 34-58, 2002; and/or (2) Cha Zhang and Zhengyou Zhang, “A Survey of Recent Advances in Face Detection”. Microsoft Tech Report, MSR-TR-2010-66, June 2010. In some examples, such methods of face detection may include: (a) neural network-based face detection as discussed in (Henry A. Rowley, Shumeet Baluja, and Takeo Kanade. “Neural Network-Based Face Detection”, IEEE Transactions on Pattern Analysis and Machine Intelligence, 1998.); and/or (b) Haar-based cascade classifier as discussed in (Paul Viola, Michael Jones, Rapid Object Detection using a Boosted Cascade of Simple Features, CVPR 2001).

Processing may continue from operation 316 to operation 318, “IDENTIFY TARGET USER”, where a target user may be identified. For example, face detection may be utilized to differentiate between a target user and a background observer. The target user and background observer may be identified based at least in part on the performed facial detection via position detection logic module 308. In some examples, the determination of the 3D distance from the 3D display to the user may be between the 3D display and the detected face of the identified target user.

Processing may continue from operation 318 to operation 320, “DETERMINE 3D DISTANCE”, where a determination of a 3D distance may be made from a 3D display to the user. For example, a determination of a 3D distance may be made from a 3D display to the user based at least in part on the received 3D visual data via position detection logic module 308.

In some examples, for a user's 3D position detection system 100 may needs to know the 3D location of the user where the 3D graphical user interface will be drawn in touchable distance. Such user location 3D sensing, may be done by depth camera, stereo camera, the like, and/or combinations thereof. For example, depth location of body components may be performed in the same or similar manner to that discussed in J. Shotton et al. Real-time Human Pose Recognition in Parts from Single Depth Images; CVPR '2011. In examples where a stereo camera is used, stereo matching algorithms, which may be performed in the same or similar manner to that discussed in D. Scharstein and R. Szeliski. “A taxonomy and evaluation of dense two-frame stereo correspondence algorithms”, International Journal of Computer Vision, 47(1/2/3):7-42, April-June 2002, may be used to acquire depth data and face detection algorithms, which may be performed in the same or similar manner to that discussed in (1) Ming-Hsuan Yang, David Kriegman, and Narendra Ahuja, “Detecting Faces in Images: A Survey”, IEEE Transactions on Pattern Analysis and Machine Intelligence (PAMI), vol. 24, no. 1, pp. 34-58, 2002; and/or (2) Cha Zhang and Zhengyou Zhang, “A Survey of Recent Advances in Face Detection”. Microsoft Tech Report, MSR-TR-2010-66, June 2010, can be used to find the head position of a user. In some examples, visual data may be captured via cheap dual-lens web-cameras to compute the depth information and upon which to detect the position of the user.

Processing may continue from operation 320 to operation 322, “ADJUST PROJECTION DISTANCE”, where a 3D projection distance from the 3D display to the user may be adjusted. For example, a 3D projection distance from the 3D display to the user may be adjusted based at least in part on the determined 3D distance to the user via projection distance logic module 309.

In some examples, a parallax for the 3D graphical user interface may be calculated during the adjustment of the 3D projection distance based at least in part on the determined 3D distance to the identified target user. Right and left views may be overlaid based at least in part on the calculated parallax.

For example, the 3D graphical user interface drawing (e.g., which may include the 3D widgets such as menus, buttons, dialog boxes, etc.) may be shown on 3D display 102. 3D display 102 gives the user depth perception through stereo imaging. It is important to place the 3D menu and 3D buttons of the 3D graphical user interface exactly in front of the user, specifically, in a comfortable touch distance to the user. After the 3D position of the user is obtained, the system 100 needs to calculate the correct parallax for these widgets and overlay them on the top of left/right views. The 3D perceptual distance may be determined by stereo parallax, human inter-ocular distance and viewer-screen distance, which may be performed in the same or similar manner to that discussed in McAllister, David F. (February 2002), “Stereo & 3D Display Technologies, Display Technology”, In Hornak, Joseph P. (Hardcover). Encyclopedia of Imaging Science and Technology, 2 Volume Set. 2. New York: Wiley & Sons. pp. 1327-1344. ISBN 978-0-471-33276-3.

Processing may continue from operation 322 to operation 324, “PRESENT 3D GUI AT ADJUSTED DISTANCE”, where the 3D GUI may be presented at the adjusted distance. For example, the 3D GUI may be presented at the adjusted distance via 3D display 102 to the user.

Processing may continue from operation 318 or 324 to operation 326, “RECEIVE VISUAL DATA”, where visual data may be received. For example, visual data may be transferred from imaging device 104 to hand gesture logic module 310, where the visual data includes 3D visual data.

Processing may continue from operation 326 to operation 328. “PERFORM HAND GESTURE RECOGNITION”, where hand gesture recognition may be performed. For example, hand gesture recognition may be performed based at least in part on the received visual data for the identified target user via hand gesture logic module 310. In some examples, the hand gesture recognition may be performed without a user input device.

In some examples, hand gesture recognition may be utilized to interpret virtual touching actions from the user interacting with the 3D graphical user interface (e.g., such as virtual touching actions) since the 3D graphical user interface is shown in front of the user. To do this, system 100 may detect the 3D position of user's hands or fingers. As touch screen supports singlepoint touch and multi-point touch, the finger/gesture on 3D graphical user interface may also support the same or similar multi-point operations. Such operations may be done with gesture recognition technique, which may be performed in the same or similar manner to that discussed in Application No. PCT/CN2011/072581,filed Apr. 11, 2011, by Xiaofeng Tong, Dayong Ding, and entitled “GESTURE RECOGNITION USING DEPTH IMAGES” Wenlong Li, Yimin Zhang, or other similar techniques.

Processing may continue from operation 328 to operation 330, “DETERMINE USER COMMAND”, where a user interface command may be determined. For example, a user interface command may be determined in response to the hand gesture recognition via hand gesture logic module 310.

In some examples, upon receiving and recognizing user's gesture/touch on the 3D graphical user interface, system 100 may take a corresponding action to translate the 3D graphical user interface in response to the user's command via gesture (e.g., on 3D graphical user interface, or close to 3D graphical user interface, or several inches from the 3D graphical user interface).

In some examples, the 3D graphical user interface may be arranged in 3D space and as the distance of fingers is measurable, special effects could be realized. For example, a menu of the 3D graphical user interface could be designed as “penetrable” and/or “non-penetrable”. For penetrable menus, the fingers can go through them and touch widgets behind. For non-penetrable menus, their position can be moved by pushed aside. In a 2D GUI, the scroll bar is laid out in x and y directions. In the 3D graphical user interface, the scroll bar could be also laid out in z direction and controlled by pushing/pulling gestures.

Processing may continue from operation 330 to operation 332, “ADJUST 3D GUI”, where the appearance of the 3D graphical user interface may be adjusted. For example, the appearance of the 3D graphical user interface may be adjusted in response to the determined user interface command via projection distance logic module 309.

Processing may continue from operation 332 to operation 334, “PRESENT ADJUSTED 3D GUI”, where the adjusted 3D GUI may be presented. For example, the adjusted 3D GUI may be presented via 3D display 102 to the user.

While implementation of example processes 200 and 300, as illustrated in FIGS. 2 and 3, may include the undertaking of all blocks shown in the order illustrated, the present disclosure is not limited in this regard and, in various examples, implementation of processes 200 and 300 may include the undertaking only a subset of the blocks shown and/or in a different order than illustrated.

In addition, any one or more of the blocks of FIGS. 2 and 3 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 2 and 3 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

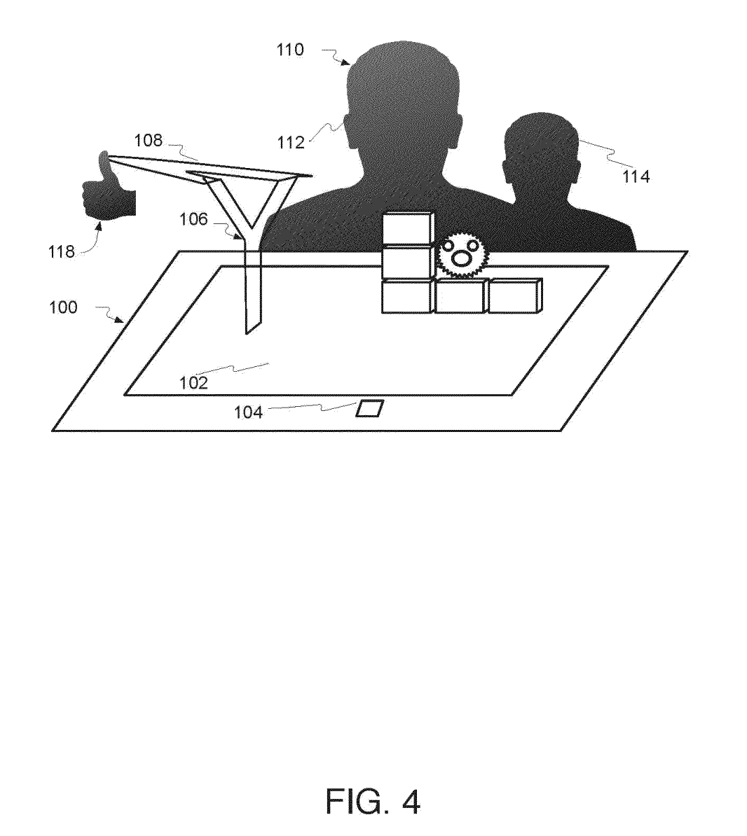

FIG. 4 is an illustrative diagram of another example 3D graphical user interface system 100 in accordance with at least some implementations of the present disclosure. In the illustrated implementation, 3D graphical user interface 106 may be presented as a 3D game on a 3D phone-type 3D graphical user interface system 100. As shown in Figure, the 3D scene may be visualized with the depth dimension on a glasses-free 3D handheld or 3D phone, such as Nintendo 3DS, HTC EVO 3D and LG Optimus 3D, for example. User 112 may be able to manipulate the 3D virtual widgets 108 directly with hands 118. The depth info, hand gestures or finger actions may be sensed with a dual-lens camera-type 3D imaging devices 104, for example.

In another example, 3D Ads may be presented on 3D digital signage. Such digital signage could use auto-stereoscopic 3D display 102 so that visitors pay special attention to the Ads without wearing special glasses. The visitors could be able to touch the virtual goods for rotating, moving, or manipulating 3D menu with fingers to finish the payment procedure. The hand gesture may be recognized by 3D imaging devices 104 (e.g., a stereo camera or depth camera) installed on the top of the digital signage.

In the example illustrated in FIG. 1, the 3D graphical user interface 106 may be implemented as 3D menu on 3D-TV. In such an implementation, user 112 may watch 3D-TV with polarize/shutter glasses. When user 112 switches TV channels or DVD chapters, the 3D menu pops-up in a touchable distance and user 112 makes selection with fingers. The Microsoft Kinect like depth camera can be equipped in set-top-box and user 112's finger action is recognized and reacted by the system.

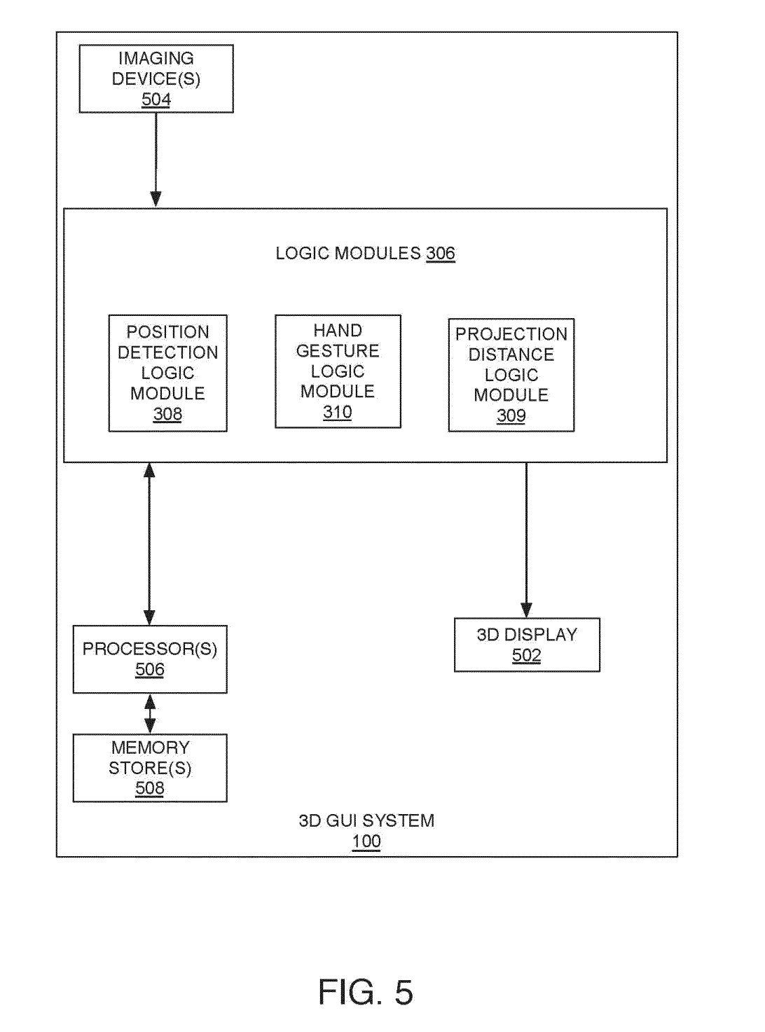

FIG. 5 is an illustrative diagram of an example 3D graphical user interface system 100, arranged in accordance with at least some implementations of the present disclosure. In the illustrated implementation, 3D graphical user interface system 100 may include 3D display 502, imaging device(s) 504, processor 506, memory store 508 and/or logic modules 306. Logic modules 306 may include position detection logic module 308, projection distance logic module 309, hand gesture logic module 310, the like, and/or combinations thereof.

As illustrated, 3D display 502, imaging device(s) 504, processor 506 and/or memory store 508 may be capable of communication with one another and/or communication with portions of logic modules 306. Although 3D graphical user interface system 100, as shown in FIG. 5, may include one particular set of blocks or actions associated with particular modules, these blocks or actions may be associated with different modules than the particular module illustrated here.

In some examples, imaging device(s) 504 may be configured to capture visual data of a user, where the visual data may include 3D visual data. 3D display device 502 may be configured to present video data. Processors 506 may be communicatively coupled to 3D display device 502. Memory stores 508 may be communicatively coupled to processors 506. Position detection logic module 308 may be communicatively coupled to imaging device(s) 504 and may be configured to determine a 3D distance from 3D display device 502 to the user based at least in part on the received 3D visual data. Projection distance logic module 309 may be communicatively coupled to position detection logic module 308 and may be configured to adjust a 3D projection distance from 3D display device 502 to the user based at least in part on the determined 3D distance to the user. Hand gesture logic module 310 may be configured to perform hand gesture recognition based at least in part on the received visual data for the identified target user, and determine a user interface command in response to the hand gesture recognition.

In various embodiments, detection logic module 308 may be implemented in hardware, while software may implement projection distance logic module 309 and/or hand gesture logic module 310. For example, in some embodiments, detection logic module 308 may be implemented by application-specific integrated circuit (ASIC) logic while distance logic module 309 and/or hand gesture logic module 310 may be provided by software instructions executed by logic such as processors 506. However, the present disclosure is not limited in this regard and detection logic module 308, distance logic module 309, and/or hand gesture logic module 310 may be implemented by any combination of hardware, firmware and/or software. In addition, memory stores 508 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 508 may be implemented by cache memory.

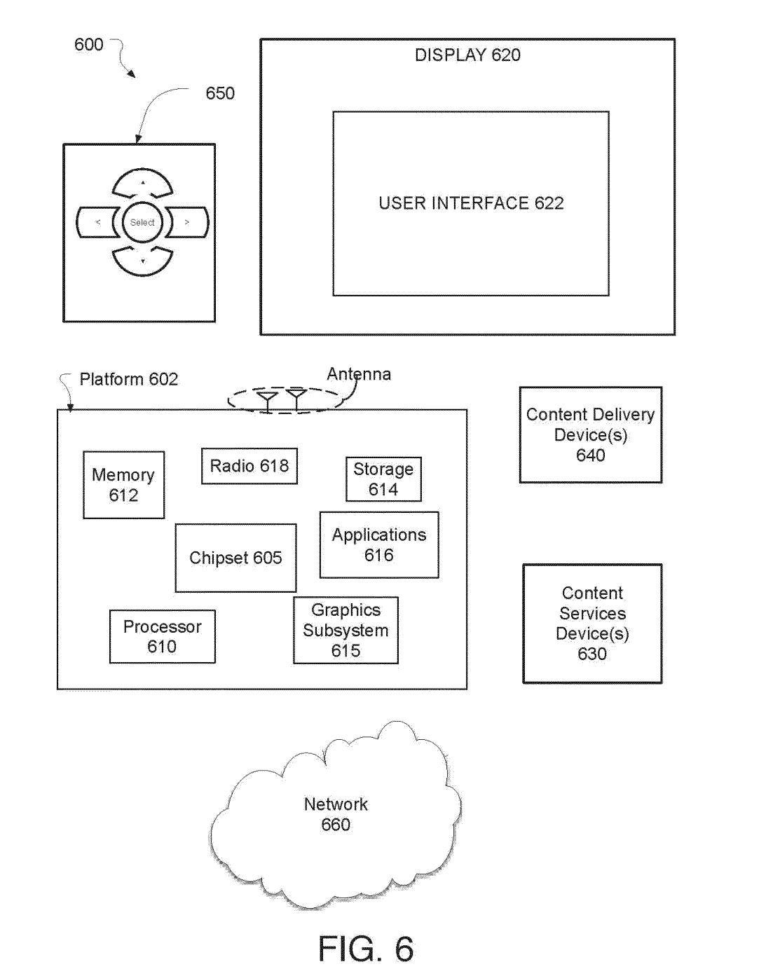

FIG. 6 illustrates an example system 600 in accordance with the present disclosure. In various implementations, system 600 may be a media system although system 600 is not limited to this context. For example, system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 600 includes a platform 602 coupled to a display 620. Platform 602 may receive content from a content device such as content services device(s) 630 or content delivery device(s) 640 or other similar content sources. A navigation controller 650 including one or more navigation features may be used to interact with, for example, platform 602 and/or display 620. Each of these components is described in greater detail below.

In various implementations, platform 602 may include any combination of a chipset 605, processor 610, memory 612, storage 614, graphics subsystem 615, applications 616 and/or radio 618. Chipset 605 may provide intercommunication among processor 610, memory 612, storage 614, graphics subsystem 615, applications 616 and/or radio 618. For example, chipset 605 may include a storage adapter (not depicted) capable of providing intercommunication with storage 614.

Processor 610 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 610 may be dual-core processor(s), dual-core mobile processor(s), and so forth.

Memory 612 may be implemented as a volatile memory device such as, but not limited to, a Random Access Memory (RAM), Dynamic Random Access Memory (DRAM), or Static RAM (SRAM).

Storage 614 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 614 may include technology to increase the storage performance enhanced protection for valuable digital media when multiple hard drives are included, for example.

Graphics subsystem 615 may perform processing of images such as still or video for display. Graphics subsystem 615 may be a graphics processing unit (GPU) or a visual processing unit (VPU), for example. An analog or digital interface may be used to communicatively couple graphics subsystem 615 and display 620. For example, the interface may be any of a High-Definition Multimedia Interface, Display Port, wireless HDMI, and/or wireless HD compliant techniques. Graphics subsystem 615 may be integrated into processor 610 or chipset 605. In some implementations, graphics subsystem 615 may be a stand-alone card communicatively coupled to chipset 605.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 618 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 618 may operate in accordance with one or more applicable standards in any version.

In various implementations, display 620 may include any television type monitor or display. Display 620 may include, for example, a computer display screen, touch screen display, video monitor, television-like device, and/or a television. Display 620 may be digital and/or analog. In various implementations, display 620 may be a holographic display. Also, display 620 may be a transparent surface that may receive a visual projection. Such projections may convey various forms of information, images, and/or objects. For example, such projections may be a visual overlay for a mobile augmented reality (MAR) application. Under the control of one or more software applications 616, platform 602 may display user interface 622 on display 620.

In various implementations, content services device(s) 630 may be hosted by any national, international and/or independent service and thus accessible to platform 602 via the Internet, for example. Content services device(s) 630 may be coupled to platform 602 and/or to display 620. Platform 602 and/or content services device(s) 630 may be coupled to a network 660 to communicate (e.g., send and/or receive) media information to and from network 660. Content delivery device(s) 640 also may be coupled to platform 602 and/or to display 620.

In various implementations, content services device(s) 630 may include a cable television box, personal computer, network, telephone, Internet enabled devices or appliance capable of delivering digital information and/or content, and any other similar device capable of unidirectionally or bidirectionally communicating content between content providers and platform 602 and/display 620, via network 660 or directly. It will be appreciated that the content may be communicated unidirectionally and/or bidirectionally to and from any one of the components in system 600 and a content provider via network 660. Examples of content may include any media information including, for example, video, music, medical and gaming information, and so forth.

Content services device(s) 630 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 602 may receive control signals from navigation controller 650 having one or more navigation features. The navigation features of controller 650 may be used to interact with user interface 622, for example. In embodiments, navigation controller 650 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 650 may be replicated on a display (e.g., display 620) by movements of a pointer, cursor, focus ring, or other visual indicators displayed on the display. For example, under the control of software applications 616, the navigation features located on navigation controller 650 may be mapped to virtual navigation features displayed on user interface 622, for example. In embodiments, controller 650 may not be a separate component but may be integrated into platform 602 and/or display 620. The present disclosure, however, is not limited to the elements or in the context shown or described herein.

In various implementations, drivers (not shown) may include technology to enable users to instantly turn on and off platform 602 like a television with the touch of a button after initial boot-up, when enabled, for example. Program logic may allow platform 602 to stream content to media adaptors or other content services device(s) 630 or content delivery device(s) 640 even when the platform is turned “off.” In addition, chipset 605 may include hardware and/or software support for 6.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 600 may be integrated. For example, platform 602 and content services device(s) 630 may be integrated, or platform 602 and content delivery device(s) 640 may be integrated, or platform 602, content services device(s) 630, and content delivery device(s) 640 may be integrated, for example. In various embodiments, platform 602 and display 620 may be an integrated unit. Display 620 and content service device(s) 630 may be integrated, or display 620 and content delivery device(s) 640 may be integrated, for example. These examples are not meant to limit the present disclosure.

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 602 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

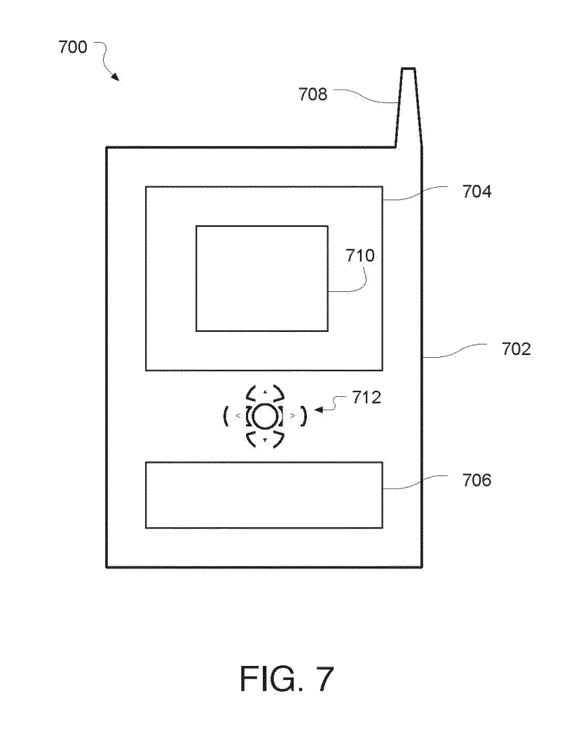

As described above, system 600 may be embodied in varying physical styles or form factors. FIG. 7 illustrates implementations of a small form factor device 700 in which system 600 may be embodied. In embodiments, for example, device 700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may include a housing 702, a display 704, an input/output (I/O) device 706, and an antenna 708. Device 700 also may include navigation features 712. Display 704 may include any suitable display unit for displaying information appropriate for a mobile computing device. 1/O device 706 may include any suitable I/O device for entering information into a mobile computing device. Examples for I/O device 706 may include an alphanumeric keyboard, a numeric keypad, a touch pad, input keys, buttons, switches, rocker switches, microphones, speakers, voice recognition device and software, and so forth. Information also may be entered into device 700 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one example, a computer-implemented method for a 3D graphical user interface may include receiving visual data of a user, where the visual data includes 3D visual data. A determination of a 3D distance may be made from a 3D display to the user based at least in part on the received 3D visual data. A 3D projection distance from the 3D display to the user may be adjusted based at least in part on the determined 3D distance to the user.

In another example, the method may further include performing facial detection for one of one or more users based at least in part on the received visual data. A target user may be identified based at least in part on the performed facial detection, where the determination of the 3D distance from the 3D display to the user may be between the 3D display and the detected face of the identified target user. A parallax for the 3D graphical user interface may be calculated during the adjustment of the 3D projection distance based at least in part on the determined 3D distance to the identified target user. Right and left views may be overlaid based at least in part on the calculated parallax. Hand gesture recognition may be performed based at least in part on the received visual data for the identified target user. A user interface command may be determined in response to the hand gesture recognition, wherein the hand gesture recognition is performed without a user input device. The appearance of the 3D graphical user interface may be adjusted in response to the determined user interface command. The 3D visual data may be obtained from one or more of the following 3D sensor types: a depth camera-type sensor, a structured light-type sensor, a stereo-type sensor, a proximity-type sensor, a 3D camera-type sensor, the like, and/or combinations thereof. The 3D display includes one or more of the following types of 3D displays: a 3D television, a holographic 3D television, a 3D cell phone, a 3D tablet, the like, and/or combinations thereof.

In other examples, a system for presenting a 3D graphical user interface on a computer may include an imaging device, a 3D display device, one or more processors, one or more memory stores, a position detection logic module, a projection distance logic module, the like, and/or combinations thereof. The imaging device may be configured to capture visual data of a user, where the visual data may include 3D visual data. The 3D display device may be configured to present video data. The one or more processors may be communicatively coupled to the 3D display device. The one or more memory stores may be communicatively coupled to the one or more processors. The position detection logic module may be communicatively coupled to the imaging device and may be configured to determine a 3D distance from the 3D display to the user based at least in part on the received 3D visual data. The projection distance logic module may be communicatively coupled to the position detection logic module and may be configured to adjust a 3D projection distance from the 3D display to the user based at least in part on the determined 3D distance to the user.

In another example, the position detection logic module may be further configured to: perform facial detection for one of one or more users based at least in part on the received visual data, and identify a target user based at least in part on the performed facial detection, where the determination of the 3D distance from the 3D display to the user may be between the 3D display and the detected face of the identified target user. The projection distance logic module may be further configured to: calculate a parallax for the 3D graphical user interface during the adjustment of the 3D projection distance based at least in part on the determined 3D distance to the identified target user, and overlay right and left views based at least in part on the calculated parallax. The system may include a hand gesture logic module that may be configured to perform hand gesture recognition based at least in part on the received visual data for the identified target user, wherein the hand gesture recognition is performed without a user input device; and determine a user interface command in response to the hand gesture recognition. The projection distance logic module may be further configured to adjust the appearance of the 3D graphical user interface in response to the determined user interface command. The 3D visual data may be obtained from one or more of the following 3D sensor types: a depth camera-type sensor, a structured light-type sensor, a stereo-type sensor, a proximity-type sensor, a 3D camera-type sensor, the like, and/or combinations thereof. The 3D display includes one or more of the following types of 3D displays: a 3D television, a holographic 3D television, a 3D cell phone, a 3D tablet, the like, and/or combinations thereof.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

1-22. (canceled)

23. A computer-implemented method for a 3D graphical user interface, comprising:
receiving visual data of a user, wherein the visual data includes 3D visual data;
determining a 3D distance from a 3D display to the user based at least in part on the received 3D visual data; and
adjusting a 3D projection distance from the 3D display to the user based at least in part on the determined 3D distance to the user.

24. The method of claim 23, wherein the 3D visual data is obtained from one or more of the following 3D sensor types: a depth camera-type sensor, a structured light-type sensor, a stereo-type sensor, a proximity-type sensor, and a 3D camera-type sensor.

25. The method of claim 23, wherein the 3D display comprises one or more of the following types of 3D displays: a 3D television, a holographic 3D television, a 3D cell phone, and a 3D tablet.

26. The method of claim 23, further comprising:
performing facial detection based at least in part on the received 3D visual data, and
wherein the determination of the 3D distance from the 3D display to the user is between the 3D display and the detected face of the user.

27. The method of claim 23, further comprising:
performing facial detection for one of one or more users based at least in part on the received visual data; and
identifying a target user based at least in part on the performed facial detection,
wherein the determination of the 3D distance from the 3D display to the user is between the 3D display and the identified target user.

28. The method of claim 23, further comprising:
performing facial detection for one of one or more users based at least in part on the received visual data; and
identifying a target user based at least in part on the performed facial detection,
wherein the determination of the 3D distance from the 3D display to the user is between the 3D display and the detected face of the identified target user.

29. The method of claim 23, further comprising:
calculating a parallax for the 3D graphical user interface during the adjustment of the 3D projection distance based at least in part on the determined 3D distance to the user, and
overlaying right and left views based at least in part on the calculated parallax.

30. The method of claim 23, further comprising:
performing hand gesture recognition based at least in part on the received visual data; and
determining a user interface command in response to the hand gesture recognition.

31. The method of claim 23, further comprising:
performing hand gesture recognition based at least in part on the received visual data, wherein the hand gesture recognition is performed without a user input device;
determining a user interface command in response to the hand gesture recognition; and
adjusting the appearance of the 3D graphical user interface in response to the determined user interface command.

32. The method of claim 23, further comprising:
performing facial detection for one of one or more users based at least in part on the received visual data;
identifying a target user based at least in part on the performed facial detection, wherein the determination of the 3D distance from the 3D display to the user is between the 3D display and the detected face of the identified target user;
calculating a parallax for the 3D graphical user interface during the adjustment of the 3D projection distance based at least in part on the determined 3D distance to the identified target user;
overlaying right and left views based at least in part on the calculated parallax;
performing hand gesture recognition based at least in part on the received visual data for the identified target user, wherein the hand gesture recognition is performed without a user input device;
determining a user interface command in response to the hand gesture recognition;
adjusting the appearance of the 3D graphical user interface in response to the determined user interface command,
wherein the 3D visual data is obtained from one or more of the following 3D sensor types: a depth camera-type sensor, a structured light-type sensor, a stereo-type sensor, a proximity-type sensor, and a 3D camera-type sensor,
wherein the 3D display comprises one or more of the following types of 3D displays: a 3D television, a holographic 3D television, a 3D cell phone, and a 3D tablet.

33. A system for presenting a 3D graphical user interface on a computer, comprising:
an imaging device configured to capture visual data of a user, wherein the visual data includes 3D visual data;
a 3D display device configured to present video data;
one or more processors communicatively coupled to the 3D display device;
one or more memory stores communicatively coupled to the one or more processors;
a position detection logic module communicatively coupled to the imaging device and configured to determine a 3D distance from the 3D display to the user based at least in part on the received 3D visual data; and
a projection distance logic module communicatively coupled to the position detection logic module and configured to adjust a 3D projection distance from the 3D display to the user based at least in part on the determined 3D distance to the user.

34. The system of claim 33, wherein the 3D visual data is obtained from one or more of the following 3D sensor types: a depth camera-type sensor, a structured light-type sensor, a stereo-type sensor, a proximity-type sensor, and a 3D camera-type sensor.

35. The system of claim 33, wherein the 3D display comprises one or more of the following types of 3D displays: a 3D television, a holographic 3D television, a 3D cell phone, and a 3D tablet.

36. The system of claim 33, wherein the position detection logic module is further configured to:
perform facial detection based at least in part on the received 3D visual data, and
wherein the determination of the 3D distance from the 3D display to the user is between the 3D display and the detected face of the user.

37. The system of claim 33, wherein the position detection logic module is further configured to:
perform facial detection for one of one or more users based at least in part on the received visual data; and
identify a target user based at least in part on the performed facial detection,
wherein the determination of the 3D distance from the 3D display to the user is between the 3D display and the identified target user.

38. The system of claim 33, wherein the position detection logic module is further configured to:
perform facial detection for one of one or more users based at least in part on the received visual data; and
identify a target user based at least in part on the performed facial detection,
wherein the determination of the 3D distance from the 3D display to the user is between the 3D display and the detected face of the identified target user.

39. The system of claim 33, wherein the projection distance logic module is further configured to:
calculate a parallax for the 3D graphical user interface during the adjustment of the 3D projection distance based at least in part on the determined 3D distance to the user, and
overlay right and left views based at least in part on the calculated parallax.

40. The system of claim 33, further comprising a hand gesture logic module configured to:
perform hand gesture recognition based at least in part on the received visual data; and
determine a user interface command in response to the hand gesture recognition.

41. The system of claim 33, further comprising a hand gesture logic module configured to:
perform hand gesture recognition based at least in part on the received visual data, wherein the hand gesture recognition is performed without a user input device;
determine a user interface command in response to the hand gesture recognition; and
wherein the projection distance logic module is further configured to adjust the appearance of the 3D graphical user interface in response to the determined user interface command.

42. The system of claim 33, further comprising:
wherein the position detection logic module is further configured to: perform facial detection for one of one or more users based at least in part on the received visual data, and identify a target user based at least in part on the performed facial detection, wherein the determination of the 3D distance from the 3D display to the user is between the 3D display and the detected face of the identified target user;
wherein the projection distance logic module is further configured to: calculate a parallax for the 3D graphical user interface during the adjustment of the 3D projection distance based at least in part on the determined 3D distance to the identified target user, and overlay right and left views based at least in part on the calculated parallax;
a hand gesture logic module configured to perform hand gesture recognition based at least in part on the received visual data for the identified target user, wherein the hand gesture recognition is performed without a user input device; and determine a user interface command in response to the hand gesture recognition;
wherein the projection distance logic module is further configured to adjust the appearance of the 3D graphical user interface in response to the determined user interface command;
wherein the 3D visual data is obtained from one or more of the following 3D sensor types: a depth camera-type sensor, a structured light-type sensor, a stereo-type sensor, a proximity-type sensor, and a 3D camera-type sensor; and
wherein the 3D display comprises one or more of the following types of 3D displays: a 3D television, a holographic 3D television, a 3D cell phone, and a 3D tablet.

43. At least one machine readable medium comprising a plurality of instructions that in response to being executed on a computing device, cause the computing device to code data by:
receiving visual data of a user, wherein the visual data includes 3D visual data;
determining a 3D distance from a 3D display to the user based at least in part on the received 3D visual data; and
adjusting a 3D projection distance from the 3D display to the user based at least in part on the determined 3D distance to the user.

44. The machine readable medium of claim 43, further comprising instructions that in response to being executed on the computing device, cause the computing device to operate by:
performing facial detection for one of one or more users based at least in part on the received visual data;
identifying a target user based at least in part on the performed facial detection, wherein the determination of the 3D distance from the 3D display to the user is between the 3D display and the detected face of the identified target user;
calculating a parallax for the 3D graphical user interface during the adjustment of the 3D projection distance based at least in part on the determined 3D distance to the identified target user;
overlaying right and left views based at least in part on the calculated parallax;
performing hand gesture recognition based at least in part on the received visual data for the identified target user, wherein the hand gesture recognition is performed without a user input device;
determining a user interface command in response to the hand gesture recognition;
adjusting the appearance of the 3D graphical user interface in response to the determined user interface command,
wherein the 3D visual data is obtained from one or more of the following 3D sensor types: a depth camera-type sensor, a structured light-type sensor, a stereo-type sensor, a proximity-type sensor, and a 3D camera-type sensor,
wherein the 3D display comprises one or more of the following types of 3D displays: a 3D television, a holographic 3D television, a 3D cell phone, and a 3D tablet.
